(19) United States
(12) Patent Application Publication
(10) Pub. No.: US 2015/0146058 A1
(43) Pub. Date: May 28, 2015

(54) Focal-Plane Shutter

(71) Applicant: Nidec Copal Corporation, Tokyo (JP)

(72) Inventor: Yasuo TANAKA, Tokyo (JP)

(73) Assignee: NIDEC COPAL CORPORATION, Tokyo (JP)

(21) Appl. No.: 14/496,277

(22) Filed: Sep. 25, 2014

(30) Foreign Application Priority Data
Sep. 25, 2013 (JP) 2013-198200

(51) Int. Cl. H04N 5/225; H04N 5/359

(52) U.S. Cl. CPC H04N 5/2254; H04N 5/3591
USPC 348/296

(57) ABSTRACT

A focal-plane shutter is provided with a driving member that drives a fore-blade, a setting component that sets the driving member into a set position prior to a shutter action, a component being attracted provided in the driving member, and electromagnets that exert attracting action by means of electrical conduction to the component being attracted under a condition where the driving member is set into the set position. The component being attracted includes an axis, a part being attracted on one end of the axis, and a flange having a curved surface curved in a convex manner on the other end of the axis. The driving member includes through-holes at designated intervals that go through the axis and two flat inclined surfaces that receive the curved surface of the flange in two locations.

### CROSS REFERENCE TO RELATED APPLICATIONS

This application claims priority under 35 U.S.C. §119 to Japanese Patent Application No. 2013-198200, filed on Sep. 25, 2013, the entire content of which being hereby incorporated herein by reference.

### FIELD OF INDUSTRY

This invention pertains to a focal-plane shutter that opens and closes the opening for exposure in such cameras as digital cameras, and pertains to a focal-plane shutter that has blades that open and close the opening for exposure.

### BACKGROUND

Traditionally, commonly known focal-plane shutters are equipped with such items as an approximately rectangular shaped base plate having an opening for exposure, freely movable fore-blades and an aft-blades (the blade parts) that opens and closes the base plate, a fore-blade driving member that activates the fore-blade, an aft-blade driving member that activates the aft-blade, moving-iron parts that are provided respectively on the fore-blade driving member (and the fore-blade) and on the aft-blade driving member (and the aft-blade), a setter that sets the setting for the fore-blade driving member (and the fore-blade) and the aft-blade driving member (and the aft-blade) prior to the operation of the shutter, two electric magnets (an iron core part and an excite coil) that apply magnetic pull to the respective moving iron parts that maintain the fore-blade driving member and the aft-blade driving member in their set positions; where immediately prior taking a photograph and immediately after the release (prior to the shutter action), the fore-blade driving member (and the fore-blade) and the aft-blade driving member (and aft-blade) are maintained in their set position by attraction even after the setting action, by applying attraction action to the to the moving-iron parts with magnetic pull of the electric magnets, is released by the setter. See, for example, Japanese Published Unexamined Application No. 2007-293293.

In order to obtain a good adsorption (contact) between the iron core part (the attraction surface part) and the moving-iron parts (the surface being attracted) in this focal-plane shutter, an electromagnet structure is used wherein the moving-iron parts are comprised of an axis, inserted into the attaching surface (the attachment hole) of the fore-blade driving member and the aft-blade driving member, a moving-iron parts that comes in contact with the iron core part provided on one end of the axis, and a retaining flange part on the other end from the axis; while also directing the iron core part toward the moving-iron parts and energizing them with a compression spring, and interposing a plate-shaped collar between the attaching surface and the flange, to make the axis portion of the moving-iron parts be suitably tilted to make the moving-iron parts and the iron core part come into close contact.

However, with the aforementioned structure, because a specialized part called a collar is used, it invites an increase in the number of parts, an increase in cost, an increase in the assembly work hours, and the like, as well as interfering with saving space.

This invention was created taking into consideration the aforementioned situation. An aspect of this invention is to provide a focal-plane shutter for cameras that reliably maintains the driving member, which drives the blades, in a desired set position with the magnetic pull of electric magnets with an aim towards structural simplicity, a decrease in the number of parts, a decrease in the number of assembly man-hours, lower cost, and space saving.

### SUMMARY

The focal-plane shutter of this invention pertains to a focal-plane shutter provided with a base plate having an opening for exposure, freely movable blades on the base plate that are to open and close the opening, a driving member energized in one direction that is to drive the blades, a setter that sets the driving member into its set-position prior to the shutter action, a part being attracted provided on the driving member, magnets that cause an attraction action through electric conduction through the part being attracted under the condition of when the driving member has been set into the set-position. The aforementioned part being attracted is provided with an axis, with on one end of the axis being provided with the attracted part that is attracted when coming in contact with electromagnets, while on the other end of the axis being included an flange having a curved convex surface facing one end. These aforementioned driving members include 2 flat inclined surfaces that have insertion holes at designated spacings that allows the axis to freely be inserted, and the curved surface of the flange to be received.

According to this structure, when the driving member (for example, the energizing spring) is positioned by the setter, acting against the energizing force, into the pre-shutter operation set-position, the attaching surface of the member being attracted comes in contact with the electromagnets (the attracting surface of the iron core part), the part being attracted is attracted by the magnetic attraction due to electrical conduction of the electromagnets, and the driving member (along with the blades) is maintained in the set position even after the setter is released. If the energization of the electromagnets is cut off thereafter, the driving member moves due to the energizing force, causing the blades to carry out the shutter action.

Here, the part being attracted, its axis part, is inserted into the holes of the driving member, and because the curved surface of the flange is supported in 2 location by 2 flat inclined surfaces of the driving member, the part being attracted can oscillate. And because of this, the attaching surface of the part being attracted can continue to oscillate, as needed on its own, to make corrections while closely in contact with the attaching surface (of the iron core part) of the electromagnets. By doing so, the part being attracted can be held by being surely attracted by the electromagnets and the driving member (along with the blades) can be surely held in a set position prior to the shutter action.

Furthermore, by not using a specialized part, such as a traditional collar, but by making the flange of the part being attracted to have a curved surface that is curved and convex, and by making it so that the two flat inclined surfaces provided on the driving member receive this curved surface, an oscillating structure is obtained that has structural simplicity, a decrease in the number of parts, lower cost, a decrease in the number of assembly man-hours, and space saving. With the aforementioned structure is included an energizing spring that forces in one direction the part being attracted as opposed to the driving member; and a configuration may be used whereby this energizing spring is positioned so that it will cause an energy force to make the curved surface of the flange to come in contact in an disengageable manner with the two flat inclined surfaces.

According to this structure, by using a biased spring, while preventing the wobbling of the part being attracted, it allows for the part being attracted to have smooth oscillating movement yet securely making the part being attracted (the attraction surface) to be closed to the electromagnets.

With the above structure, such a configuration can be used where the driving member includes the aforementioned two flat inclined surfaces configured in a position so that they are line symmetric with the first line that is vertical to the center line of the insertion holes, and 2 run offs configured that are formed to become non-contact with the curved surface of the flange that is positioned line symmetric to the second line that is vertical to the center line and the first line.

According to this structure, because the part being attracted is supported in a freely oscillating manner respectively within the plane that includes the first line and the plane that includes the second line by 2 contact points between its curved surface of the flange and the two flat inclined surfaces of the driving member, swinging in all directions is made possible, which is the composite of both swinging directions; which is to say that oscillation is enabled.

In the aforementioned structure, a configuration may be used such as where the driving member is positioned in a freely rotating manner around the designated axis; the axis of the through hole is positioned on a plane that is vertical to the axis of the driving member; the first line positioned on a plane that is vertical to the driving member axis, while the second line is position parallel to the driving member axis.

According to this structure, if the driving member is configured to revolve around the designated axis (such as a drive lever), by using such structural positioning, the surface being attracted of the component being attracted (the part being attracted) will carry out smooth correctional movement (oscillating actions) while consistently being closed to the attaching surface of the electromagnet (the iron core part).

With the focal-plane shutter according to the aforementioned structure, structural simplicity, a decrease in the number of parts, lower cost, a decrease in the number of assembly man-hours, and space saving can be achieved while, by means of the magnetic attraction of the electromagnets, securely maintaining the driving member that activates the blade component in the desired set position.

### BRIEF DESCRIPTION OF DRAWINGS

FIG. 1 is a plane figure depicting an example of a focal-plane shutter according to this invention indicating the state where the driving member (and the blade components) completed the shutter action (exposure action).

FIG. 2 is a plane figure depicting an example of a focal-plane shutter according to this invention indicating the state where the setter is in the middle of setting the driving member (and the blade components) into the set position.

FIG. 3 is a plane figure depicting an example of a focal-plane shutter according to this invention indicating the state where the setter has set the driving member (and the blade components) into the set position.

FIG. 4 is a plane figure depicting an example of a focal-plane shutter according to this invention indicating the state where after the driving member (and the blade components) has been set into the set-position, by electrifying the electromagnets with a release signal, or such, the components being attracted are attached and maintained and the setting components have been returned to their resting position (prior to the shutter action).

FIG. 5 is a sectional plane figure depicting the driving member (fore-blade drive lever, aft-blade drive lever) and the components being attracted, the setting components, and such, included in the focal-plane shutter according to this invention.

FIG. 6 is an external perspective view depicting the driving member (the mounting retainer part only of the fore-blade drive lever, aft-blade drive lever) and the components being attracted, and such, included in the focal-plane shutter according to this invention.

FIG. 7 is a sectional drawing showing the driving member indicated in FIG. 6 (the mounting retainer part only of the fore-blade drive lever, aft-blade drive lever) and the components being attracted, and the energizing spring, and such, in the state indicated in FIG. 1 and FIG. 2.

FIG. 8 is a sectional drawing showing the driving member indicated in FIG. 6 (the mounting retainer part only of the fore-blade drive lever, aft-blade drive lever) and the components being attracted, and the energizing spring, and such, in the state indicated in FIG. 3.

FIG. 9 is a sectional drawing showing the driving member indicated in FIG. 6 (the mounting retainer part only of the fore-blade drive lever, aft-blade drive lever) and a section of the components being attracted; where (a) is a cross-sectional drawing of the plane that contains the central line S in FIG. 6 and the second line L2, and (b) is a cross-sectional drawing of the plane that contains the central line S in FIG. 6 and the first line L1.

### DETAILED DESCRIPTION

Examples of this invention will be described below referring to the accompanying drawings.

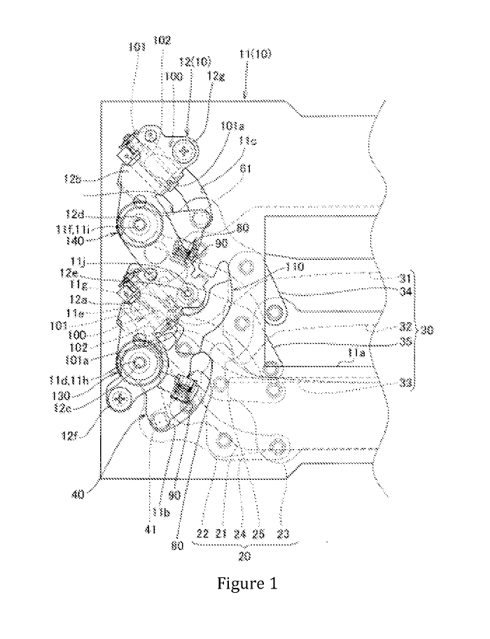

The focal-plane shutter of this example, as seen in FIG. 1 through FIG. 6, is equipped with a base plate 10 (main base plate 11 and retaining plate 12), the fore-blade 20 and the aft-blade 30 as the blade components, the fore-blade drive lever 40 and the energizing spring 50 as the driving member that activate the fore-blade 20; the aft-blade drive lever 60 and energizing spring 70 as the driving member that activates the aft-blade 30; the part being attracted 80 and energizing spring 90 each provided on the fore-blade drive lever 40 and aft-blade drive lever 60; two electromagnets 100 (iron core component 101, a coil for exciting 102) provided for each of the part being attracted 80 of the fore-blade drive lever 40 and the aft-blade drive lever 60 to magnetically cause attraction; a setter component 110 and energizing spring 120 that sets the fore-blade drive lever 40 and the aft-blade drive lever 60 into the set-position prior to shutter action (the exposure action).

To the main base plate 11 of the base plate 10 is affixed at designated spacing an intermediate plate (not shown) that demarcates the blade housing that stores the fore-blade 20 on the opposite side of the retaining plate 12 and an accessory plate (not shown) that demarcates the blade housing that stores aft-blade 30.

The base plate 10, as shown in FIG. 1 through FIG. 4, is equipped with a flat board-shaped main base plate 11 that demarcates the substantially rectangular opening 11a for exposure and a retaining plate 12 that is affixed at designated spacings to the main base plate 11.

The main base plate 11, as shown in FIG. 1 through FIG. 4, is equipped with an opening 11a, a circular arc shaped long-hole 11b and a long-hole 11c; spindles 11d, 11e that support in an freely rotatable manner the fore-blade 20 created on the blade housing side; spindles 11f and 11g that support in a freely rotatable manner the aft-blade 30; a spindle 11h that demarcates the axis line V that supports the fore-blade drive lever 40 in a freely rotating manner created on the outside of the blade housing; a spindle 11i that demarcates the axis line V that supports the aft-blade drive lever 60 in a freely rotating manner created on the outside of the blade housing; and a spindle 11j that supports the setting components 110 in a freely rotating manner created on the outside of the blade housing.

The retaining plate 12, as seen FIG. 1 through FIG. 4, is equipped with gripping chucks 12a, 12b that hold the two electromagnets 100, and fitting holes 12c, 12d, and 12e that fit and stabilize the spindles 11h, 11i, and 11j; and the stabilizing members 12f, and 12g that stabilize the main base plate 11 with screws.

The fore-blade 20, as shown in FIG. 1 through FIG. 4, is comprised of 3 blades 21, 22, and 23; and two arms 24, and 25 that link the blades 21, 22 and 23.

A portion of the arm 24, along with being supported in a freely rotatable manner by the spindle 11d is linked to the drive pin 41 of the fore-blade drive lever 40.

Arm 25 is supported in a freely rotatable manner by the spindle 11e.

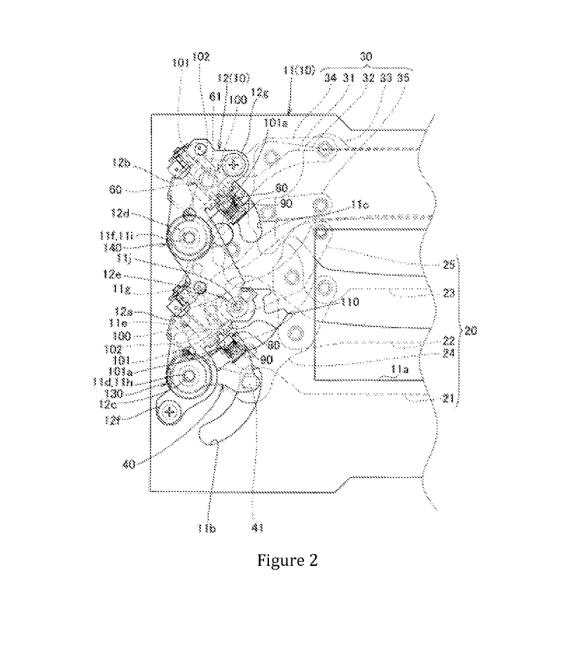

As shown in FIG. 2 through FIG. 4, by the arm 24 being driven in an upward direction (counter clockwise) by the fore-blade lever 40, the 3 blade bodies 21, 22, and 23 are deployed and the opening 11a is closed; while at the same time, as shown in FIG. 1, by it being driven in a downward direction (clockwise) by the fore-blade drive lever 40, the 3 blade bodies 21, 22, and 23 overlap to open the opening 11a.

The aft-blade 30, as shown in FIG. 1 through FIG. 4, is comprised of 3 blades 31, 32, and 33; and two arms 34 and 35 that link the blades 31, 32, and 33.

Arm 34, along with being supported in a freely rotatable manner by the spindle 11f, a portion of it is linked to the drive pin 61 of the aft-blade drive lever 60.

Arm 35 is supported in a freely rotatable manner by the spindle 11g.

As shown in FIG. 2 through FIG. 4, by the arm 34 being driven in an upward direction (counter clockwise) by the aft-blade drive lever 60, the 3 blade bodies 31, 32, and 33 overlap and the opening 11a is opened; while at the same time, as shown in FIG. 1, by it being driven in a downward direction (clockwise) by the aft-blade drive lever 60, the 3 blade bodies 31, 32, and 33 are deployed and the opening 11a is closed.

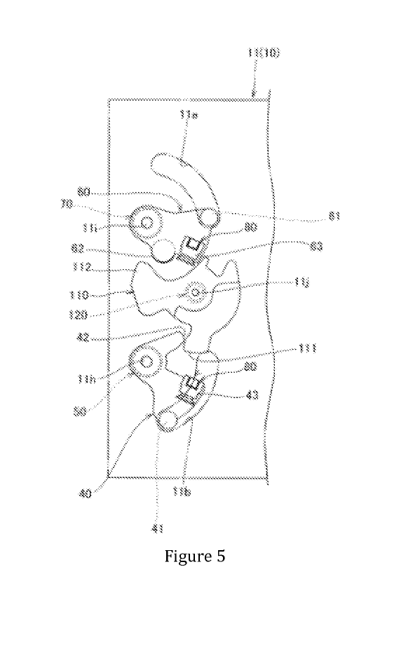

The fore-blade drive lever 40, as shown in FIG. 5, is equipped with a drive pin 41 to which the arm 24 is connected, an engaging portion 42 to which a counterclockwise rotation force is applied by engaging the setting component 110, an attaching retainer part 43, and such, that attaches and holds the part being attracted 80, and is supported in a freely rotating manner by the spindle 11h.

The drive pin 41 is inserted into the long hole 11b of the main base plate 11, and at the same time is made to hit a shock absorbing component (not shown) such as rubber, that is affixed to the long hole 11b on a clockwise rotating tip.

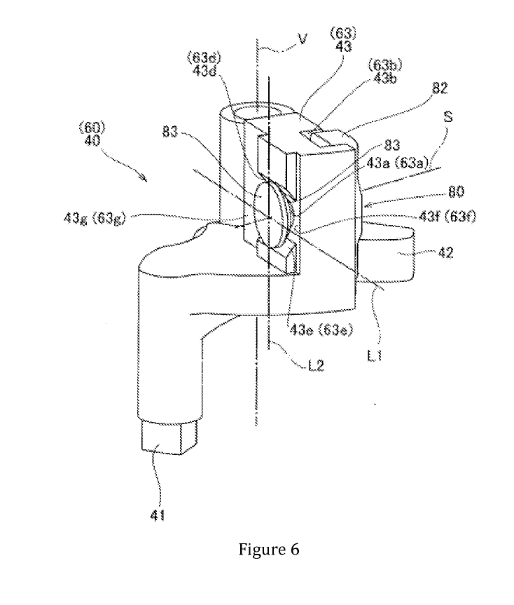

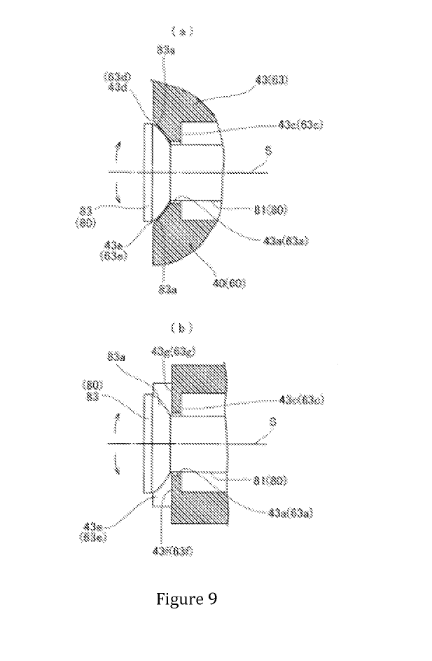

The attaching retainer part 43, as shown in FIG. 6 through FIG. 9, is equipped with through holes 43a through which the axis 81 of the component being attracted 80 is inserted at designated spacings, a concave member 43b that receives in a freely movable manner the part being attracted 82 of the component being attracted 80, a circular concave member 43c that receives and causes to abut one end of the energizing spring 90, 2 two flat inclined surfaces 43d and 43e that receive in two areas the curved surface 83a of the flange 83 of the component being attracted 80; and 2 run offs 43f and 43g configured to not allow them to have contact with the curved surface 83a of the flange 83 of the component being attracted 80.

The through hole 43a, as shown in FIG. 6 through FIG. 9, not only demarcates the central line S within the flat plane vertical to the axial line V around which fore-blade drive lever 40 revolves, but is also formed in a manner that the inner diameter of the axis 81 of the component being attracted 80 is larger than the external diameter of the axis 81 allowing for it to freely incline in relationship to the central line S within the designated angular range.

The concave member 43b is formed to the dimensions that allow for the movement of part being attracted 82 when the axis 81 is inclined due to the intersection of parts, or the like.

The annular concave part 43c not only receives at designated spacings one end of the coil shaped energizing spring 90, but is also formed in such a manner to cause it to abut in the direction of the central line S.

The two flat inclined surfaces, 43d and 43e, as shown in FIG. 6 through FIG. 9(a), is not only configured in a position so that it is axially symmetric to the first line L1 that is vertical to the axial line V and the central line S of the through hole 43a, but is also formed as a flat surface having a designated inclined angle in relation to the central line S so as to come in contact with the curved surface 83a of the flange 83 of the component being attracted 80.

The two run-off parts 43f and 43g, as shown in FIG. 6 through FIG. 9(b), is not only configured in such a position so that it is in axial symmetry to the second line L2 that is parallel to the axial V and vertical to the first line L1 and the central line S of the through-hole 43a, but is also formed as an end surface parallel to the plane that is vertical to the central line S so as not to come in contact with the curved surface 83a of the flange 83 of the component being attracted 80.

The energizing spring 50, which is a torsion coil spring, as shown in FIG. 5, is situated around the spindle 11h, and a portion of it is hooked around a portion of the fore-blade drive lever 40, while the other end (not shown) is hooked on the adjusting wheel (ratchet cylinder) 130 situated on the retaining plate 12 side together with same axial spindle 11h.

The aft-blade drive lever 60, as shown in FIG. 5, is equipped with a drive pin 61 to which the arm 34 is connected, an engaging portion 62 to which a counterclockwise rotation force is applied by engaging the setting component 110, an attaching retainer part 63, and such, that mounts and supports the part to be attracted 80 that is supported in a freely revolving manner by the spindle 11i.

The drive pin 61 is inserted into the through-hole 11c of the main base plate 11, and at the same time is made to hit a shock absorbing component (not shown), such as rubber, that is affixed to the long hole 11c on a clockwise rotating tip and stop.

The attaching retainer part 63, as shown in FIG. 6 through FIG. 9, is equipped with through-holes 63a through which the axis 81 of the component being attracted 80 is inserted at designated spacings, a concave member 63b that receives in a freely movable manner the part being attracted 82 of the component being attracted 80, a circular concave member 63c that receives and causes to abut one end of the energizing spring 90, 2 two flat inclined surfaces 63d and 63e that receive in two areas the curved surface 83a of the flange 83 of the component being attracted 80, and 2 run offs 63f and 63g configured not to allow them to have contact with the curved surface 83a of the flange 83 of the component being attracted 80.

The through hole 63a, as shown in FIG. 6 through FIG. 9, not only demarcates the central line S within the flat plane vertical to the axial line V around which aft-blade drive lever 60 revolves, but is also formed in a manner that the inner diameter of the axis 81 of the component being attracted 80 is larger than the external diameter of the axis 81 allowing for it to freely incline in relationship to the central line S within the designated angular range.

The concave member 63b is formed to the dimensions that allow for the movement of part being attracted 82 when the axis 81 is inclined due to the intersection of parts, or the like.

The annular concave part 63c not only receives at designated spacings one end of the coil shaped energizing spring 90, but is also formed in such a manner so that it will abut in the direction of the central line S.

The two flat inclined surfaces, 63d and 63e, as shown in FIG. 6 through FIG. 9(a), is not only configured in a position so that it is axially symmetric to the first line L1 that is vertical to the axial line V and the central line S of the through hole 63a, but is also formed as a flat surface having a designated inclined angle in relation to the central line S so as to come in contact with the curved surface 83a of the flange 83 of the component being attracted 80.

The two run-off parts 63f and 63g, as shown in FIG. 6 through FIG. 9(b), is not only configured in such a position so that it is axially symmetric to the second line L2 that is parallel to the axial V and vertical to the first line L1 and the central line S of the through-hole 63a, but is also formed as an end surface parallel to the plane that is vertical to the central line S so as not to come in contact with the curved surface 83a of the flange 83 of the component being attracted 80.

The energizing spring 70, which is a torsion coil spring, as shown in FIG. 5, is situated around the spindle 11i, and a portion of it is hooked around a portion of the fore-blade lever 60, while the other end (not shown) is hooked on the adjusting wheel (ratchet cylinder) 140 situated on the retaining plate 12 side together with same axial spindle 11i, and is configured to cause an energizing force on the

aft-blade drive lever 60 to rotate in a clockwise manner in FIG. 5 as a rotational force.

The component being attracted 80, as shown in FIG. 6 through FIG. 9, is equipped with the axis 81 that is passes through the through-holes 43a and 63a of the attaching retainer part 43, and is situated on one end of the axis member 81, as well as situated on the other end of the axis member 81, and the part being attracted 82 that comes in contact with the electromagnets 100, and is also equipped with a flange 83 having a curved convex surface 83a in the direction of one end.

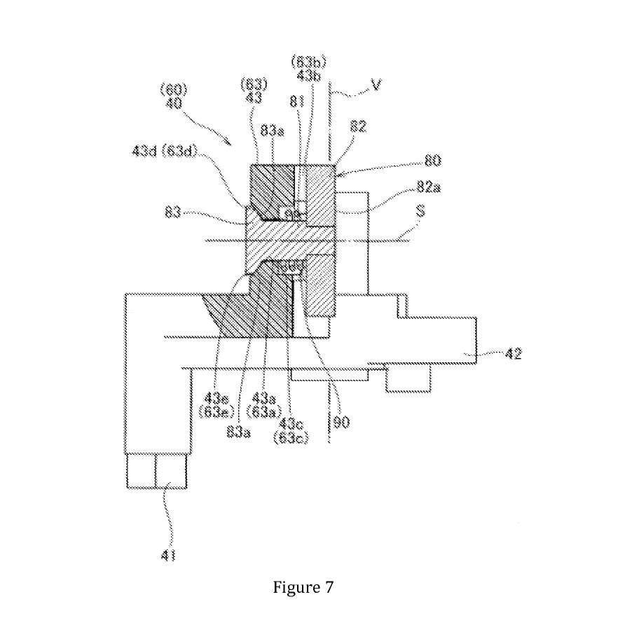

The axis 81, as shown in FIG. 7 through FIG. 9, is formed to have a smaller external diameter than the internal diameter of the through-holes 43a and 63a to enable inclination within a designated angular range in relation to the central line S of the through-holes 43a and 63a.

This part being attracted 82, as shown in FIG. 6 through FIG. 8, is fixedly connected to the axis part 81 formed approximately in a rectangular shape, and is fitted into the concave parts 43b and 63b of the attaching retainer parts 43 and 63, while also being equipped with a flat surface part being attracted 82a by being in contact with the adsorption surface 101a of the iron core part 101 of the electromagnets 100.

The flange part 83, as shown in FIG. 6 through FIG. 9, has a curved surface 83a that is convex in the direction of one of the ends of the axis 81 (part being attracted 82), and the curved surface 83a is formed to detachably be in contact at two points with 63d and 63e and the two flat inclined surfaces 43d and 43e of the attaching retainer part 43 and 63.

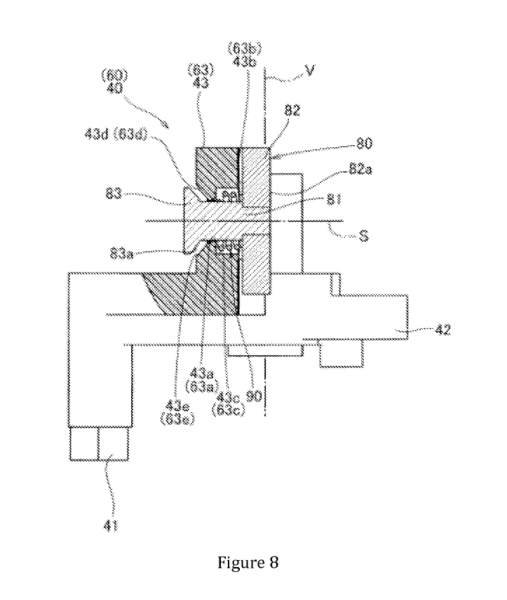

The energizing spring 90, as shown in FIG. 7 through FIG. 8, is a compression type coil spring, is passed through the axis 81 of the component being attracted 80 at designated spacing, and also has one end (in designated spacings between the inner peripheral surface) stored and abutted in the annular concave portions 43c and 63c of the attaching retainer part 43 and 63, and the other end is compressed to a designated compression level and fitted in and abutted to a portion (the opposite side of the component being attracted 83a) of the part being attracted 82 of the component being attracted 80.

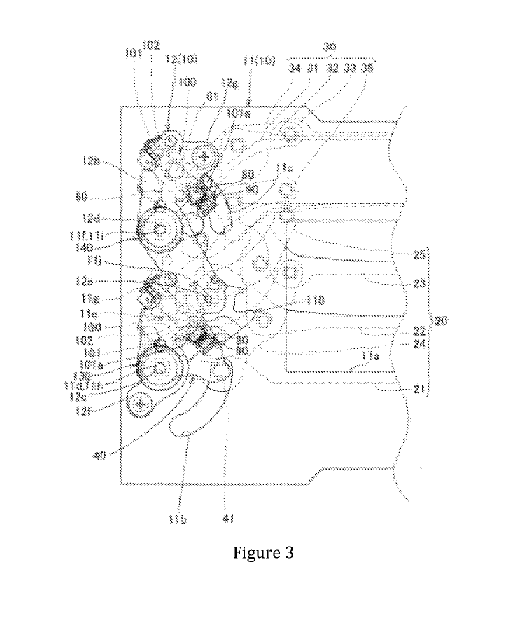

Furthermore, the energizing spring 90, as shown in FIG. 7, as the curved surface 83a of the flange 83 exerts biasing force as to abut (as shown in FIGS. 1 and 2, the surface to be attracted 82a of the part to be attracted 82 abuts before in contact with the absorption surface 101a of the electromagnets 100) the two flat inclined surfaces 43d, 43e and 63d, and 63e of the attaching retainer parts 43 and 63, as shown in FIG. 8, the curved surface 83a of the flange 83 also allows [the energizing spring 90] to detach (as shown in FIG. 3, the fore-blade drive lever 40 and the aft-blade drive lever 60 are detached in a state of being set in a set position by the setter 110) from the two flat inclined surfaces 43d, 43e, and 63d, 63e of the attaching retainer part 43 and 63.

The electromagnets 100, as shown in FIG. 1 through FIG. 4, is structured with a iron core component 101 having a designated length, and with an exciting coil 102, or the like, that is wrapped around the bobbin on the periphery of the iron core component 101 in such a way so as to be retained by the mounting retainer parts 12a and 12b of the retaining plate 12.

The iron core component 101 is equipped with a flat attaching surface 101a in contact with and attracted the surface to be attracted 82a of the part to be attracted 80 (the part to be attracted 82).

Furthermore, due to the electrical conduction to the coil 102, they [the electromagnets 100] generate magnetic lines of force that pass through the iron core part 101, and exert magnetic attraction force to the surface being attracted 82a of the component being attracted 80 facing them.

In this way, because the axis 81 of the component being attracted 80 is inserted into the through-hole 43a (63a) of the driving members (40, 60) and the curved surface 83a of the flange 83 is supported in two places by the two flat inclined surfaces 43d, 43e (63d, 63e) of the mounting retainer 43 (63), the neck of the component being attracted 80 is able to oscillate in an angular fashion in relationship to the central line S; Because of this, the surface being attracted 82a of the part being attracted 82 can make appropriate corrective movements of its own accord while closely in contact with the attaching surface 101a of the iron core part 101 of the electromagnets 100.

Especially, because the two flat inclined surfaces 43d, 43e (63d, 63e) are created to such that they are axially symmetric to the first line L1 that is vertical to the central line S of the through-hole 43a (63a), and the two run-offs 43f, 43g (63f, 63g) are made so as not to come in contact with the curved surface 83a of the flange 83 in the axially symmetric position relative to the second line L2 that is vertical to the first line L1 and the central line S, so the component being attracted 80 is supported in a freely oscillating manner respectively within the plane that includes the first line L1 and the plane that includes the second line L2 by 2 contact points between the curved surface 83a of the flange 83 and the two flat inclined surfaces 43d, 43e (63d, 63e), swinging in all directions is made possible, which is the composite of both swinging directions; which is to say, oscillation is enabled.

Furthermore, central line S of the through-hole 43a is situated on the plane that is vertical to the axial line V of the driving members (40, 60), the first line L1 is situated vertical to the axial line V of the driving members (40, 60), and the second line L2 is situated parallel to the axial line V of the driving members (40, 60), so in a structure where the lever configuration revolves around the designated axial line V of the driving members (40, 60), the surface being attracted 82a of the component being attracted 80 (the part being attracted 82) can continuously be making smooth adjustments (oscillating motions) in relation to the attaching surface 101a of the electromagnets 100 (the iron core components 101).

Because the energizing spring 90 that energizes the component being attracted 80 in one direction is provided for the driving members (attaching retainer parts 43, 63), and because it is situated so as to exert an energizing force that causes the curve surface 83a of the flange 83 to come in contact in a detachable manner to the two flat inclined surfaces 43d, 43e (63d, 63e), the wobbling of the component being attracted 80 is being prevented, causing the component being attracted 80 to smoothly oscillate, enabling the surface being attracted 82a of the component being attracted 82 to be closely drawn to the surface being attracted 101a of the electromagnets 100.

According to the above structure, the component being attracted 80 can be securely attracted and retained with the electromagnets 100, and the driving members (40, 60) and the blade components (fore-blade 20 and aft-blade 30) can be securely retained in the set-position that is prior to the shutter action.

Especially, by configuring the flange 83 of the component being attracted 80 into a curved surface 83a that curves in a convex form without using such traditional specialized components of the conventional collar components, or the like, by configuring it so that curved surface 83a is received by the two flat inclined surfaces 43d, 43e, 63d, 63e provided on the driving members (40 and 60), structural simplicity, a decrease in the number of parts, lower cost, a decrease in the number of assembly man-hours, and space saving can be achieved, and a structure allowing oscillation can be obtained.

The setting component 110 is supported in a freely rotating manner by the spindle 11j as shown in FIG. 1 through FIG. 5, and it is equipped with an engaging member 111 engaged to the engaging member 42 of the fore-blade drive lever 40, an engaging member 112 engaged to the engaging member 62 of the aft-blade drive lever 60, and a connecting part (not shown) that connects a portion of the driving mechanism (not shown) that exerts a rotational driving force from the camera main body.

The energizing spring 120 is a swing coil spring, and as shown in FIG. 5, is situated surround the spindle 11j, with one end portion being hooked to a portion of the setting component 110 while the other end portion (not shown) being hooked to a portion of the base plate 10 (main base plate 11 or support plate 12), and it is formed so as to exert a biasing force that rotates and biases counterclockwise in FIG. 5 around the setting component 110.

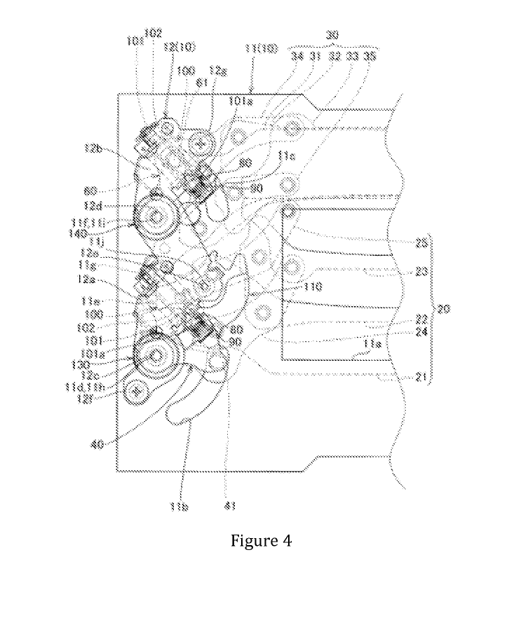

And when the setting component 110 is rotated clockwise under the state shown in FIG. 1 and FIG. 5, the engaging member 111 exerts a rotational force to the engaging member 42 and the engaging member 112 exerts a rotational force to the engaging member 62, and as shown in FIG. 2 and FIG. 3, the fore-blade drive lever 40 and the aft-blade drive lever 62 act against the rotational biasing force of the energizing force 50 and 70 to be rotated counterclockwise, and are held in the setting position prior to the shutter action; meanwhile, when being rotated clockwise in a state where the fore-blade drive lever 40 in the setting position is attracted and held by the electromagnets 100, and the aft-blade drive lever 60 is attracted and held by the electromagnets 100, as shown in FIG. 4, the engaging member 111 detaches from the engaging member 42 and the engaging member 112 detaches from the engaging member 62, allowing clockwise rotation of the fore-blade drive lever 40 and the aft-blade drive lever 60.

Next, the actions of this focal-plane shutter will be described with reference to FIG. 1 through FIG. 4, and FIG. 7 through FIG. 9.

As for the resting state after the shutter action (exposure action) is completed, as shown in FIG. 1, the setting component 110 rotates counterclockwise and is positioned in the resting position, the fore-blade drive lever 40 rotates clockwise due to the rotational force of the energizing spring 50 and stops,
the fore-blades 20 are positioned in the position where the opening 11a is left open, and the aft-blade drive lever 60 rotates clockwise due to the rotational force of the energizing spring 70 and stops, and the aft-blades 30 are positioned in the position where the opening 11a is left closed; in this condition, as shown in FIG. 7, the curved surface 83a of the flange component 83 of the component being attracted 80, due to the energizing force of the energizing spring 90, is abutted to the two flat inclined surfaces 43e, 43e and 63d and 63e of the attaching retainer part 43 and 63.

At this time, if the preparation command is issued for the shutter action (action to set), as shown in FIG. 2, the setting component 110 rotates clockwise, the engaging member 111 engages with the engaging member 42, allowing the fore-blade drive lever 40 to rotate counterclockwise, and the engaging member 112 engages with the engaging member 62, allowing the aft-blade drive lever 60 to rotate counterclockwise, whereby the surface being attracted 82a of the component being attracted 80 provided on the fore-blade drive lever 40 begins to abut the attaching surface 101a of the electromagnets 100, and the surface being attracted 82a of the component being attracted 80 provided on the aft-blade drive lever 60 begins to abut the corresponding attaching surface 101a of the electromagnets 100.

Then, as shown in FIG. 3, the setting component 110 further rotates clockwise, and in the process whereby the fore-blade drive lever 40 and aft-blade drive lever 60 are further rotated counterclockwise, as shown in FIG. 8, the curved surface 83a of the flange 83, acting against the energizing force of the energizing spring 90, detaches from the two flat inclined surfaces 43d, 43e, and 63d, 63e of the attaching retainer part 43, 63. When the respective surfaces being attracted 82a of the component being attracted 80 are hitting the shoulders (partially coming in contact), because they are configured to have a smaller external diameter than the internal diameter of the through-holes 43a and 63a so as to enable the axis to be able to incline within a designated angular range in relationship to the central line S of the through-holes 43a and 63a, it will be corrected by appropriately slanting so as to allow the surface being attracted 83a to completely be in contact with the attracting surface 101a, and then the fore-blade drive lever 40 (and the fore-blade 20) is positioned into the set-position (the state where the opening 11a is closed) prior to the shutter action (prior to exposure), and the aft-blade drive lever 60 (and the aft-blade 30) is positioned into the set-position (the state where the opening 11a is open) prior to the shutter action (prior to exposure).

After that, due to a release signal, or the like, if the electromagnets 100 (the coil thereof 102) are electrically conducted, the attracting surface 101a of the iron core component 101 adsorbs the surface being attracted 83a of the component being attracted 80 by magnetic attraction, acting against the biasing force of the energizing spring 50 and 70 that energizes in clockwise direction, to securely hold and position the fore-blade drive lever 40 and the aft-blade drive lever 60 in the set-position.

Then, as shown in FIG. 4, when the setting component 110 rotates counterclockwise and returns to the resting position, the engaging member 111 is detached from the engaging member 42 and the engaging member 112 is detached from the engaging member 62, releasing the state of the clockwise rotation of fore-blade drive lever 40 and aft-blade drive lever 60 being mechanically controlled.

Again, as shown in FIG. 7, the component being attracted 80 abuts, due to the biasing force of the energizing spring 90, the two flat inclined surfaces 43d, 43e, and 63d, 63e of the attaching retainer part 43, 63 that is the curved surface 83a of the flange 83. However, at that time, if the surface being attracted 82a is hitting shoulders with the surface being attracted 101a by component tolerance, the curved surface 83a and the two flat inclined surfaces 43d, 43e carry out appropriate oscillating actions by two-point contact, and they will be automatically corrected so as to allow the curved surface 83a to come into complete close contact with the attracting surface 101a.

If the conduction of the two electromagnets 100 are cut off at respectively different timings, firstly, the fore-blade drive lever 40 rotates clockwise due to the biasing force of the energizing spring 50 and the fore-blade 20 is activated, and then after a designated period of time, the aft-blade drive lever 60 rotates clockwise due to the biasing force of the energizing spring 70 to activate the aft-blade 30, and as shown in FIG. 1, the fore-blade 20 opens the opening 11a and the aft-blade 30 closes the opening 11a.

As is indicated, the opening and closing action for the opening 11a is carried out by the fore-blade 20 and aft-blade 30, and the shutter actions are completed.

As can be seen from above, according to this focal-plane shutter, structural simplicity, a decrease in the number of parts, lower cost, a decrease in the number of assembly man-hours, and space saving can be achieved, while driving members (fore-blade drive lever 40 and aft-blade drive lever 60) that drive the blade components (fore-blade 20 and aft-blade 30) can be securely maintained in the desired position.

In the aforementioned examples, where the structures equipped with the fore-blades 20 and aft-blades 30, the structure of this invention (curved surface 83a of the component being attracted 80, the through-holes 43a and 63a of the attaching retainer part 43, 63, and the two flat inclined surfaces 43d, 43e, and 63d, 63e) was used for the fore-blade drive lever 40 and aft-blade drive lever 60; that is to say, a case was shown where 2 blade components were used. However, it is not limited thereto. For example, the invention of this application can be used in a structure where it is equipped with one blade component and the shutter action is simply to move the opening from an open state to a close state.

In the aforementioned structure, for the attaching retainer parts 43 and 63 of the driving member (fore-blade drive lever 40 and aft-blade drive lever 60), the structure wherein the two flat inclined surfaces 43d, 43e, (63d, 63e) are situated in an axially symmetric manner to the first line L1 that is vertical to the axial line V; and the 2 run-offs 43F, and 43g (63f and 63g) were situated in an axially symmetric manner to the second line L2 that is parallel to the axial V was adopted. But it is not limited to this [structure], rather a structure where each is rearranged may be used.

With the above examples, for the driving members, the fore-blade drive lever 40 and the aft-blade drive lever 60 that revolve around the designated axial line V were used, but it is not limited thereto. This invention can be applied to the examples that use other forms of driving members.

As stated above, the focal-plane shutter of this invention achieves structural simplicity, a decrease in the number of parts, a decrease in the number of assembly man-hours, lower cost, and space saving, making it possible to securely maintain the driving member, which drives the blades, in a desired set position with the magnetic pull of electromagnets; therefore, it can clearly be used in cameras such as silver halide film-type cameras, digital cameras, and so on, as well as be beneficial to other optical devices equipped with exposure openings.

1. A focal-plane shutter comprising:
a base plate having an opening for exposure;
blade components installed in a freely movable manner in the base plate that open and close the opening;
driving components energized in one direction to activate the blade components;
setting components that set the setting position of the driving components, acting against the biasing force, into a set position prior to shutter actions;
a component being attracted provided in the driving members; and
electromagnets that exert magnetic attraction, due to electrical conduction, upon the component being attracted while the driving members are set in their set-position, wherein
the component being attracted includes an axis part, an attaching surface being installed on one end of the axis and coming in contact with and being attracted to the electromagnets, and a flange that is installed on the other end of the axis and also has a curved surface that is curved in a convex manner toward one end, and
the driving member includes through-holes at designated spacings that allow the axes to be freely inserted, and two flat inclined surfaces that receive in two locations the curved surface of the flange.

2. The focal-plane shutter of claim 1, wherein
the driving members include an energizing spring that energizes the component being attracted in one direction, and
the energizing spring is situated in a manner so as to exert biasing energy on the curved surface of the flange, causing it to come in contact with the two flat inclined surfaces in a detachable manner.

3. The focal-plane shutter of claim 1, wherein
the driving components include two flat inclined surfaces positioned axially symmetric to the first line that is vertical to the central line of the through-holes and two run-offs that are configured to be not in contact with the curved surfaced of the flange, and are situated in a position axially symmetric to the second line that is vertical to the first line and the aforementioned central line.

4. The focal-plane shutter of claim 3, wherein
the driving components are situated in a freely rotating manner around the designated axis,
the central line of the through-holes is situated on a plane vertical to the axial line,
the first line is situated on the plane vertical to the axial line, and
the second line is situated on the plane parallel to the axial line.
